(19) United States
(12) Patent Application Publication
(10) Pub. No.: US 2022/0394067 A1
(43) Pub. Date: Dec. 8, 2022

(54) SYSTEM AND METHOD FOR FACILITATING INTERACTION AMONG USERS AT REAL-TIME

(71) Applicant: Hermis, Inc., Saratoga, CA (US)

(72) Inventors: Madhusudan Mathihalli, Saratoga, CA (US); Mohan Gummalam, Palo Alto, CA (US)

(21) Appl. No.: 17/834,978

(22) Filed: Jun. 8, 2022

Related U.S. Application Data
(60) Provisional application No. 63/208,170, filed on Jun. 8, 2021.

(51) Int. Cl. H04L 65/403; G06F 3/14; G06F 9/54

(52) U.S. Cl. CPC H04L 65/403; G06F 3/1454; G06F 9/547

(57) ABSTRACT

A system and method for facilitating interactions among users at real-time is disclosed. The method includes receiving a request to interact with one or more other electronic devices associated with one or more other users, establishing a connection between one or more electronic devices and the one or more other electronic devices and receiving a multimedia data. The method further includes receiving one or more multimedia inputs corresponding to the received multimedia from a user and determining one or more screenshare settings associated with the received multimedia data. Further, the method includes determining one or more specific contents of the multimedia data, generating one or more icons associated with one or more desired activities and transmitting the determined one or more specific contents and the generated one or more icons to each of the one or more electronic devices and the one or more other electronic devices.

### EARLIEST PRIORITY DATE

This Application claims priority from a Provisional patent application filed in the United States of America having Patent Application No. 63/208,170, filed on Jun. 8, 2021, and titled “SYSTEM AND METHOD FOR CREATING STRUCTURED ACTIVITIES USING VISUAL AND AUDIO CONFERENCING”.

### FIELD OF INVENTION

Embodiments of the present disclosure relate to audio and video conferencing systems and more particularly relate to a system and method for facilitating interaction among users at real-time.

### BACKGROUND

With the advancements in technology, many organizations are using virtual meetings platforms to allow interaction between multiple participants over the internet. Generally, the interactions may be virtual and non-verbal in nature. Further, the virtual meeting platforms have become mainstream in both personal and professional settings. However, conventional virtual meeting platforms are optimized for either casual conversations or for structured meetings. Also, the conventional virtual meeting platforms are optimized for interactions between two participants and occasionally with multiple people. Furthermore, the conventional virtual meeting platforms are designed for enterprise customers is optimized for virtual meetings occurring in corporate settings, participants have similar background and experience. In the conventional virtual meeting platforms, all participants in the virtual meeting are equal except a meeting organizer having few more controls for meeting settings. Further, the virtual meetings organized through the conventional virtual meeting platforms have a pre-defined agenda where one or more topics are discussed with or without sharing a common content and a single attendee is allowed to share content at any given time. The primary goal of the virtual meetings is for information dissemination. Furthermore, the prevalent design of the conventional virtual meeting platforms is not optimized for the multiple participants to have simultaneous conversations. However, there are a vast set of use cases, such as casual gaming, group coaching classes, families or friends socializing for an event and the like, that needs a different set of controls from an underlying system to deliver an interactive experience. These use cases have a sub-optimal experience with the conventional virtual meeting platforms and there is a lot of human coordination that is required to have a meaningful experience.

Hence, there is a need for an improved system and method for facilitating interaction among users at real-time, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system facilitating interaction among users at real-time is disclosed. The computing system includes one or more hardware processors and a memory coupled to the one or more hardware processors. The memory includes a plurality of modules in the form of programmable instructions executable by the one or more hardware processors. The plurality of modules include a request receiver module configured to receive a request from one or more electronic devices associated with a user to interact with one or more other electronic devices associated with one or more other users. The request includes type of the user, one or more desired activities for interaction between the user and the one or more other users, type of the one or more desired activities and type of the one or more users. The type of the user and the type of the one or more other users include at least one of: one or more participants, one or more visitors, one or more administrators, one or more observers, one or more organizers and one or more creators. The user is identified as a single attendee. The plurality of modules includes a connection establishing module configured to establish a connection between the one or more electronic devices and the one or more other electronic devices to allow interaction by using the one or more desired activities. One or more Application Programming Interface (APIs) allow the interaction by using the one or more desired activities. The one or more APIs include at least one of: a video-conferencing API, a gaming API and an audio-conferencing API. Further, the plurality of modules include a multimedia receiver module configured to receive a multimedia data from each of the one or more electronic devices and the one or more other electronic devices upon establishing the connection. The received multimedia data is stored in a storage unit. The multimedia data include one or more audio streams, one or more video streams, one or more audio files, one or more video files, screensharing content, one or more images and one or more texts associated with the interaction between the user and the one or more other users. The plurality of modules also include an input receiver module configured to receive one or more multimedia inputs corresponding to the received multimedia from the user. Furthermore, the plurality of modules include a screen setting determination module configured to determine one or more screenshare settings associated with the received multimedia data based on the received request, the received one or more multimedia inputs and a set of predefined screensharing rules. The plurality of modules include a multimedia determination module configured to determine one or more specific contents of the multimedia data for each of the one or more electronic devices and the one or more other electronic devices based on the received request, the received one or more multimedia inputs and the determined one or more screenshare settings. Further, the plurality of modules include an icon generation module configured to generate one or more icons associated with the one or more desired activities for each of the one or more electronic devices and the one or more other electronic devices based on the received request, the received one or more multimedia inputs, the determined one or more screenshare settings, the determined one or more specific contents and a predefined icon information. The plurality of modules include a data transmission module configured to transmit the determined one or more specific contents and the generated one or more icons to each of the one or more electronic devices and the one or more other electronic devices. The determined one or more specific contents is outputted to allow interaction between the user and the one or more other users by performing the one or more desired activities.

In accordance with another embodiment of the present disclosure, a method for facilitating interaction among users at real-time is disclosed. The method includes receiving a request from one or more electronic devices associated with a user to interact with one or more other electronic devices associated with one or more other users. The request includes type of the user, one or more desired activities for interaction between the user and the one or more other users, type of the one or more desired activities and type of the one or more users. The type of the user and the type of the one or more other users include at least one of: one or more participants, one or more visitors, one or more administrators, one or more observers, one or more organizers and one or more creators. The user is identified as a single attendee. The method further includes establishing a connection between the one or more electronic devices and the one or more other electronic devices to allow interaction by using the one or more desired activities. One or more APIs allow the interaction by using the one or more desired activities. The one or more APIs include at least one of: a video-conferencing API, a gaming API and an audio-conferencing API. Further, the method includes receiving a multimedia data from each of the one or more electronic devices and the one or more other electronic devices upon establishing the connection. The received multimedia data is stored in a storage unit. The multimedia data include one or more audio streams, one or more video streams, one or more audio files, one or more video files, screensharing content, one or more images and one or more texts associated with the interaction between the user and the one or more other users. Also, the method includes receiving one or more multimedia inputs corresponding to the received multimedia from the user. Further, the method includes determining one or more screenshare settings associated with the received multimedia data based on the received request, the received one or more multimedia inputs and a set of predefined screensharing rules. The method includes determining one or specific more contents of the multimedia data for each of the one or more electronic devices and the one or more other electronic devices based on the received request, the received one or more multimedia inputs and the determined one or more screenshare settings. Further, the method includes generating one or more icons associated with the one or more desired activities for each of the one or more electronic devices and the one or more other electronic devices based on the received request, the received one or more multimedia inputs, the determined one or more screenshare settings, the determined one or more specific contents and a predefined icon information. The method includes transmitting the determined one or more specific contents and the generated one or more icons to each of the one or more electronic devices and the one or more other electronic devices. The determined one or more specific contents is outputted to allow interaction between the user and the one or more other users by performing the one or more desired activities.

Embodiment of the present disclosure also provide a non-transitory computer-readable storage medium having instructions stored therein that, when executed by a hardware processor, cause the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1A is a block diagram illustrating an exemplary computing environment for facilitating interaction among users at real-time, in accordance with an embodiment of the present disclosure;

FIG. 1B is a block diagram illustrating an exemplary activity that can be built using the system APIs in accordance with an embodiment of the present disclosure;

FIG. 2 is a block diagram illustrating the exemplary computing system for facilitating interaction among users at real-time, in accordance with an embodiment of the present disclosure;

FIGS. 3A-3J are process flow diagrams illustrating an exemplary operation of the computing system for facilitating interaction among users at real-time, in accordance with an embodiment of the present disclosure;

FIG. 4 is a process flow diagram illustrating an exemplary method for facilitating interaction among users at real-time, in accordance with an embodiment of the present disclosure; and

FIGS. 5A-5D are graphical user interface screens of the computing system for facilitating interaction among users at real-time, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

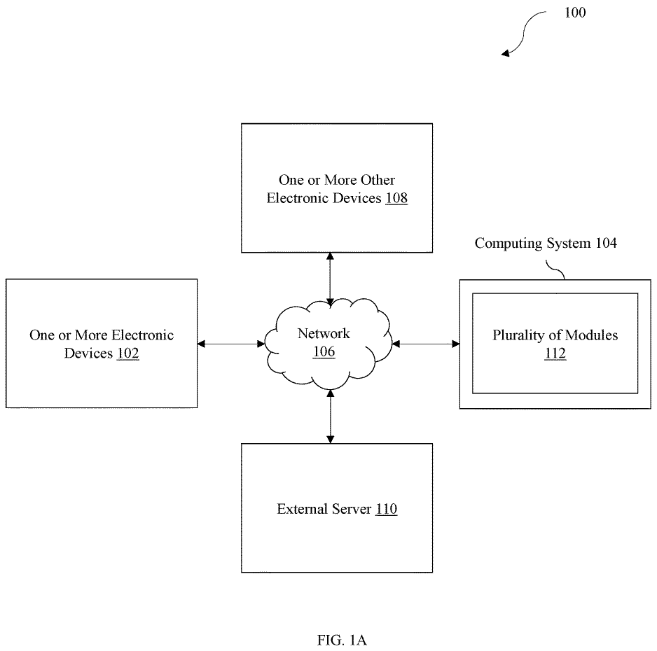

Referring now to the drawings, and more particularly to FIG. 1A through FIG. 5D, where similar reference characters denote corresponding features consistently throughout the figures, there are shown preferred embodiments and these embodiments are described in the context of the following exemplary system and/or method.

FIG. 1A is a block diagram illustrating an exemplary computing environment 100 for facilitating interaction among users at real-time, in accordance with an embodiment of the present disclosure. According to FIG. 1A, the computing environment 100 includes one or more electronic devices 102 associated with a user communicatively coupled to a computing system 104 via a network 106. The one or more electronic devices 102 are used by the user to request interaction with one or more other electronic devices 108 associated with one or more other users. The one or more electronic devices 102 are also used by the user to receive one or more specific contents of multimedia data. In an exemplary embodiment of the present disclosure, the one or more electronic devices 102 may include a laptop computer, desktop computer, tablet computer, smartphone, wearable device, smart watch, and the like. In an embodiment of the present disclosure, the computing system 104 may be hosted on a central server, such as cloud server or a remote server. Further, the network 106 may be internet or any other wireless network.

Further, the computing environment 100 includes the one or more other electronic devices 108 associated with the one or more other users communicatively coupled to the computing system 104 via the network 106. In an embodiment of the present disclosure, the one or more other electronic devices 108 are used by the one or more other users for communicating with the one or more electronic devices 102. In an embodiment of the present disclosure, the user and the one or more other users may include one or more participants, one or more visitors, one or more administrators, one or more observers, one or more organizers, one or more creators or a combination thereof. In an exemplary embodiment of the present disclosure, the one or more other electronic devices 108 may include a laptop computer, desktop computer, tablet computer, smartphone, wearable device, smart watch, and the like. The computing environment 100 also includes an external server 110 communicatively coupled to the computing system 104 via the network 106. The external server 110 hosts one or more applications to be loaded on to the computing system 104.

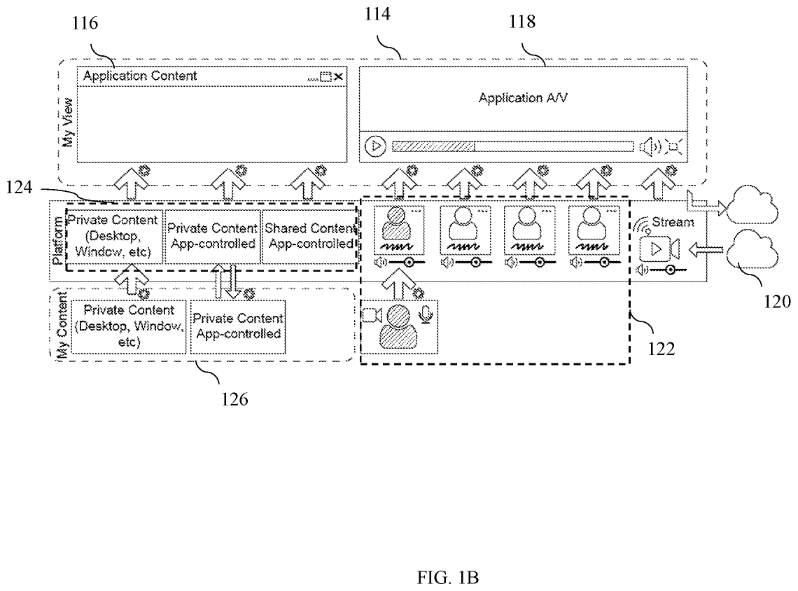

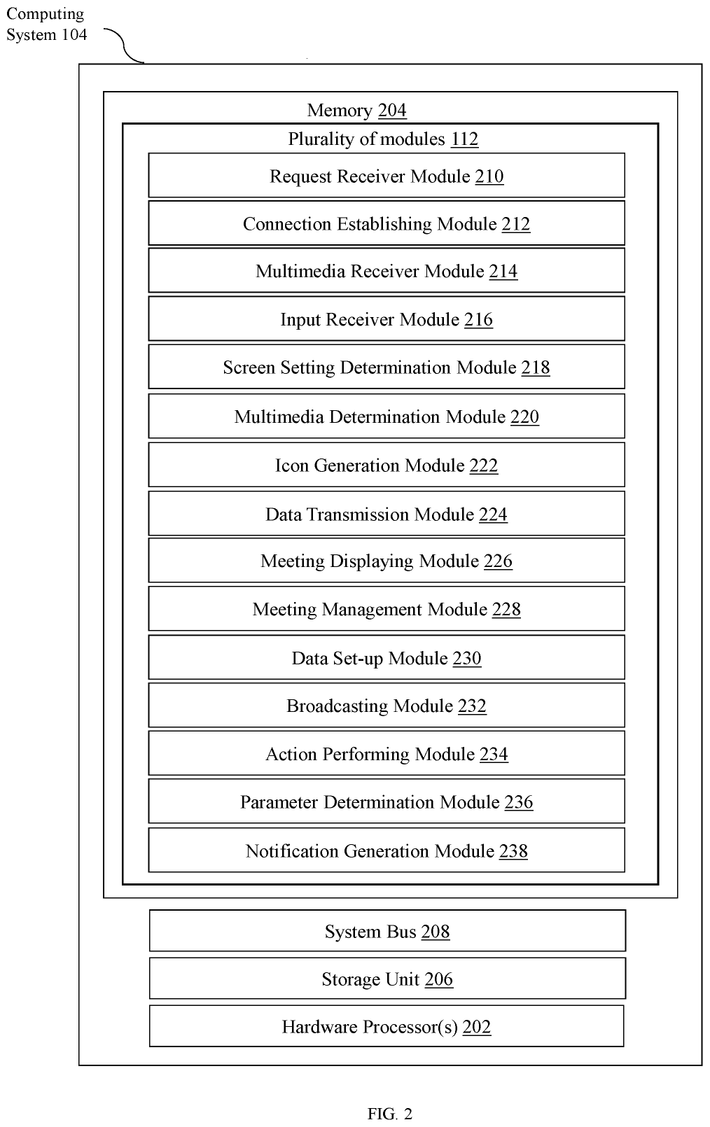

Furthermore, the one or more other electronic devices 108 and the one or more electronic device include a local browser, a mobile application. or a combination thereof. The user and the one or more other users may use a web application via the local browser, the mobile application, or a combination thereof to communicate with the computing system 104. In an embodiment of the present disclosure, the computing system 104 includes a plurality of modules 112. Details on the plurality of modules 112 have been elaborated in subsequent paragraphs of the present description with reference to FIG. 2.

In an embodiment of the present disclosure, the computing system 104 is configured to receive a request from one or more electronic devices 102 associated with a user to interact with one or more other electronic devices 108 associated with one or more other users. The request includes type of the user, one or more desired activities for interaction between the user and the one or more other users, type of the one or more desired activities, type of the one or more users and the like. The type of the user and the type of the one or more other users include one or more participants, one or more visitors, one or more administrators, one or more observers, one or more organizers and one or more creators or a combination thereof. Further, the computing system 104 establishes a connection between the one or more electronic devices 102 and the one or more other electronic devices 108 to allow interaction by using the one or more desired activities. In an embodiment of the present disclosure, one or more Application Programming Interface (APIs) allow the interaction by using the one or more desired activities. The one or more APIs include a video-conferencing API, a gaming API, an audio-conferencing API or a combination thereof. The computing system 104 receives a multimedia data from each of the one or more electronic devices 102 and the one or more other electronic devices 108 upon establishing the connection. The received multimedia data is stored in a storage unit. In an exemplary embodiment of the present disclosure, the multimedia data include one or more audio streams, one or more video streams, one or more audio files, one or more video files, screensharing content, one or more images, one or more texts associated with the interaction between the user and the one or more other users and the like. The computing system 104 receives one or more multimedia inputs corresponding to the received multimedia from the user. Furthermore, the computing system 104 determines one or more screenshare settings associated with the received multimedia data based on the received request, the received one or more multimedia inputs and a set of predefined screensharing rules. The computing system 104 determines one or more specific contents of the multimedia data for each of the one or more electronic devices 102 and the one or more other electronic devices 108 based on the received request, the received one or more multimedia inputs and the determined one or more screenshare settings. The computing system 104 generates one or more icons associated with the one or more desired activities for each of the one or more electronic devices 102 and the one or more other electronic devices 108 based on the received request, the received one or more multimedia inputs, the determined one or more screenshare settings, the determined one or more specific contents and a predefined icon information. The computing system 104 transmits the determined one or more specific contents and the generated one or more icons to each of the one or more electronic devices 102 and the one or more other electronic devices 108. The determined one or more specific contents is outputted to allow interaction between the user and the one or more other users by performing the one or more desired activities.

FIG. 1B is a block diagram illustrating an exemplary activity that can be built using the system APIs in accordance with an embodiment of the present disclosure. In an embodiment of the present disclosure, FIG. 1B represents one view of an application with different sections. 114 represents application content 116 and application A/V 118. Further, the application content 116 is viewed by all users in a meeting. In an embodiment of the present disclosure, the application A/V 118 represents audio or video of an application, such as YouTube video, which is visible to all the users. For example, 114 represents a video conferencing solution with screensharing mode, such that the video conferencing solution is the application content 116 and the screensharing mode is the application A/V 118. 120 represents audio stream. Furthermore, 122 represent video tiles of the all the users. In an embodiment of the present disclosure, the platform is configured to access private and shared content 124. For example, the private content includes desktop, window, and the like. In an embodiment of the present disclosure, the private content may also be application controlled. For example, the private content may include calendar which is private to the user and is not shared with any other user. In an embodiment of the present disclosure, the shared content is application controlled or user controlled. The shared content may be shared with all other users or to specific other users. The user may select the specific other users to whom the shared content may be shared. For example, meeting transcript may be shared with only specific other users. In an embodiment of the present disclosure, the content to be shared with the specific other users may be selected by the computing system 104 or the user. In an embodiment of the present disclosure, 126 represents the private content and the private content application controlled.

FIG. 2 is a block diagram illustrating an exemplary computing system 104 for facilitating interaction among users at real-time, in accordance with an embodiment of the present disclosure. Further, the computing system 104 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 112 in the form of programmable instructions executable by the one or more hardware processors 202. Further, the plurality of modules 112 includes a request receiver module 210, a connection establishing module 212, a multimedia receiver module 214, an input receiver module 216, a screen setting determination module 218, a multimedia determination module 220, an icon generation module 222, a data transmission module 224, a meeting displaying module 226, a meeting management module 228, a data set-up module 230, a broadcasting module 232, an action performing module 234, a parameter determination module 236 and a notification generation module 238.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 112 stored in the form of machine-readable instructions on any of the above-mentioned storage media and may be in communication with and executed by the one or more hardware processors 202.

The storage unit 206 may be a cloud storage. The storage unit 206 may store the received request, the received multimedia, the one or more multimedia inputs, the one or more screenshare settings, the one or more specific contents, the one or more icons, one or more meeting inputs, one or more action inputs, one or more interaction inputs, one or more interactive inputs, one or more audio inputs, one or more background themes, one or more push notifications and the like.

The request receiver module 210 is configured to receive the request from the one or more electronic devices 102 associated with the user to interact with the one or more other electronic devices 108 associated with one or more other users. In an exemplary embodiment of the present disclosure, the request includes type of the user, one or more desired activities for interaction between the user and the one or more other users, type of the one or more desired activities, type of the one or more users and the like. For example, the type of the user and the type of the one or more other users include one or more participants, one or more visitors, one or more administrators, one or more observers, one or more organizers, one or more creators or a combination thereof. In an embodiment of the present disclosure, the user is identified as a single attendee even if multiple electronic devices are used by the user as opposed to different attendee-id for each device. For example, the computing system 104 provides an ability for a user to participate in a meeting from multiple devices for specific parts of an activity, these may be related for both device inputs or outputs. In an exemplary embodiment of the present disclosure, the one or more electronic devices 102 and the one or more other electronic devices 108 may include a laptop computer, desktop computer, tablet computer, smartphone, wearable device, smart watch, and the like. The user may use the one or more electronic devices 102 to participate in a meeting. The user may use audio input, video input, keyboard or mouse input, drawing input, audio output, video output using the one or more electronic devices 102 or other device. In an embodiment of the present disclosure, the registered user is user registered in the computing system 104 with an email or phone number, usemame, a profile pic and the like. Further, an unregistered user exists only as a visitor. The one or more participants are users who participate in the one or more desired activities. The one or more visitors are users who just attend meetings. In an embodiment of the present disclosure, the one or more desired activities are end-user activities performed by the user and the one or more users using the computing system 104, such as playing poker, playing karaoke, watching a video in group and the like. Furthermore, the one or more administrators are users who administrate meetings. The one or more observers are users who just observe the one or more desired activities. The one or more organizers are users with extended privileges on the meetings. Further, the one or more creators are users who created the meetings. In an embodiment of the present disclosure, the meetings are current or future meetings with IDs.

The connection establishing module 212 is configured to establish a connection between the one or more electronic devices 102 and the one or more other electronic devices 108 to allow interaction by using the one or more desired activities. In an embodiment of the present disclosure, one or more APIs allow the interaction by using the one or more desired activities. The one or more APIs include a video-conferencing API, a gaming API, an audio-conferencing API, or a combination thereof. In an embodiment of the present disclosure, the one or more APIs are exposed to applications, which provide necessary activities for end users to interact with, for a registration process by which the application is recognized a configuration process by which the application to describes itself and a communication process by which the application interacts with the platform.

The multimedia receiver module 214 is configured to receive the multimedia data from each of the one or more electronic devices 102 and the one or more other electronic devices 108 upon establishing the connection. The received multimedia data is stored in the storage unit 206. In an exemplary embodiment of the present disclosure, the multimedia data include one or more audio streams, one or more video streams, one or more audio files, one or more video files, screensharing content, one or more images and one or more texts associated with the interaction between the user and the one or more other users. In an embodiment of the present disclosure, the multimedia may correspond to an item. The item corresponds to content used in a meeting that can be a screenshare, content produced by an activity or an audio/video stream from any source. There can be more than one item in the virtual meeting. Each Item has an Owner. Further, one or more attendees of the virtual meeting can be owners of the item.

The input receiver module 216 is configured to receive the one or more multimedia inputs corresponding to the received multimedia from the user. In an exemplary embodiment of the present disclosure, the one or more inputs include instructions to split the user and the one or more others users in one or more groups, providing a different set of controls and a different set of privileges to each of the one or more groups, providing access of the multimedia data corresponding to each of the one or more groups to one or more administrators, mute the one or more administrators when they are in the one or more groups, disable one or more controls of the one or more administrators when they are in the one or more groups, deny access of interaction between the one or more administrators to the user and the one or more others users in the one or more groups, enable or disable a video feed from users, enable or disable an audio feed from users or a combination thereof. When a number of the users that enabled or disabled the audio feed or the video feed for a particular user surpasses a predefined threshold, the one of audio feed and the video feed are automatically enabled or disabled for the particular user for all other users. In an embodiment of the present disclosure, the one or more groups correspond to a collection of attendees i.e., users and not visitors, formed prior to or after the start of virtual meeting, they exist only in the context of a virtual meeting. An attendee may be part of the one or more groups, but an activity may limit that behavior. In an embodiment of the present disclosure, the one or more multimedia inputs may be provided using one or more controls to allowing alteration of video and/or audio stream using predefined filters provided by the computing system 104. The user may also use a video stitching feature to allow multiple video tiles from different attendees to give the appearance of being physically next to each other.

The screen setting determination module 218 is configured to determine the one or more screenshare settings associated with the received multimedia data based on the received request, the received one or more multimedia inputs and the set of predefined screensharing rules. In an exemplary embodiment of the present disclosure, the one or more screenshare settings includes one or more specific users allowed to view screen of each of the user and the one or more other users, one or more elements on screen allowed to be shared with each of the user and the one or more other users, a common space that is viewed by each of the user and the one or more other users, a personal space that exposes the one or more elements of screen sharing to the one or more specific users and a local space that only a presenter is allowed to one of: view and use. The computing system 104 is also configured to generate the common space, the personal space, and the local space. For example, the common space may be visible to every participant in meeting, the personal space for content is tailored by the activity for each user and the local space for non-activity generated content, such as desktop, that the user can access. In another embodiment of the present disclosure, the one or more screenshare settings are also defined by the user. For example, the one or more elements may be scoreboard, video tiles and the like. In an exemplary embodiment of the present disclosure, an application may be built using the APIs exposed by a platform. During a video conferencing session, attendees can communicate with each other via voice, video and screen sharing. Screen sharing includes sharing the presenter's desktop with different types of documents including, images and video. There are various controls for screen sharing where the presenter can choose to share the entire desktop or a single application.

The multimedia determination module 220 is configured to determine the one or more specific contents of the multimedia data for each of the one or more electronic devices 102 and the one or more other electronic devices 108 based on the received request, the received one or more multimedia inputs and the determined one or more screenshare settings.

The icon generation module 222 is configured to generate the one or more icons associated with the one or more desired activities for each of the one or more electronic devices 102 and the one or more other electronic devices 108 based on the received request, the received one or more multimedia inputs, the determined one or more screenshare settings, the determined one or more specific contents and the predefined icon information. For example, the one or more icons may correspond to scoreboards, name of players, name of participants, card images, win, lose and the like.

The data transmission module 224 is configured to transmit the determined one or more specific contents and the generated one or more icons to each of the one or more electronic devices 102 and the one or more other electronic devices 108. In an embodiment of the present disclosure, the determined one or more specific contents is outputted to allow interaction between the user and the one or more other users by performing the one or more desired activities. For example, certain activities like team-based games or casino style games, the granularity of sharing requirements vary greatly based on the application. For example, not all users may or should see the exact same window. In activities, like Taboo or Poker, the player (attendee holding the card) and the opponent teams may see card details while player's team should not be able to see any of the card details. All the attendees should be able to see and hear everything the player is communicating and also have access to common elements on the screen like video tiles, scoreboard and other common elements. Such activities require granular screen sharing controls and not just at an application window level but at an attendee level too.

In an embodiment of the present disclosure, the meeting displaying module 226 is configured to display one or more ongoing virtual meetings and one or more upcoming virtual meetings of the user on the user interface screen of the one or more electronic devices 102.

The meeting management module 228 is configured to receive one or more meeting inputs for a virtual meeting from the user. In an exemplary embodiment of the present disclosure, the one or more meeting inputs include a document to review, a meeting agenda, one or more action items, a set timer to review the document and the like. Further, the meeting management module 228 performs one or more meeting actions during the virtual meeting based on the received one or more meeting inputs. In an exemplary embodiment of the present disclosure, the one or more meeting actions include displaying the document during the virtual meeting, running the timer during the virtual meeting, defining layout of video tiles, displaying the meeting agenda during the virtual meeting and the like. For example, most prevalent video conferencing solutions enable the capabilities like breakout rooms, there are several limitations that prevent them from emulating real-life scenarios. Administrators or observers may witness the conversation happening in each of the breakout rooms but without participating or registering in any of the rooms. The computing system 104 enables granular controls to selectively mute and disable certain controls for administrators or observers when they're in a room. The system also ensures that none of the attendees in the breakout rooms can hear any chatter between the administrators or observers.

The data set-up module 230 is configured to receive one or more action inputs from the user for loading one or more applications associated with the one or more APIs. Further, the data set-up module 230 loads the one or more applications by using the one or more APIs based on the received one or more action inputs, a predefined loading agenda or a combination thereof. The data set-up module 230 determines one or more requirements of the loaded one or more applications based on the received request and the received one or more action inputs. Furthermore, the data set-up module 230 sets-up one or more required controls and one or more privileges for the loaded one or more applications based on the determined one or more requirements. The data set-up module 230 receives one or more interaction inputs from the user to interact with the one or more applications for the one or more desired activities. The data set-up module 230 updates the one or more required controls and the one or more privileges for the user based on the received one or more interaction inputs. For example, the one or more required controls may be to share screen, audio, video, and the like from users. The one or more privileges include requesting users to share screen, audio and the like. For example, when the user logs on to the computing system 104, they are primarily interacting with the computing system 104 through an application. The entire experience of the user is controlled by a set of activities that are provided by various applications that are running on the computing system 104. The applications can either be loaded by the user through an explicit action or by the system automatically with a predefined program or agenda. When the application is loaded up, the computing system 104 understands the needs of the application and sets-up necessary privileges and controls for the application. As the user interacts with the application for an activity, the application communicates with the platform through the API to change the privileges and controls for the user.

The broadcasting module 232 receives the multimedia data from the one or more electronic devices 102 associated with the user. Further, the broadcasting module 232 broadcasts the received multimedia data at real-time to the one or more other electronic devices 108 associated with the one or more other users for synchronized sharing of the multimedia data. For example, in applications like Karaoke or video sharing, it's very important that all attendees always see the exact same screen as synchronized viewing is a critical need of the application. In the prevalent version of screen sharing, the presenter plays the video/audio stream which is broadcast to all other attendees. The attendees will experience a lag between when they get the audio/video feed vs the presenter. Furthermore, the quality of the audio/video feed as experienced by the attendees is determined by the uplink bandwidth quality of the presenter. To enable a more synchronized experience, the computing system 104 allows for certain types of content, such as video, audio, documents, to be rendered on the server and all the attendees get the exact same content. For example, the computing system 104 pre-fetch and load common content on the server and live broadcast to all attendees simultaneously.

The action performing module 234 receives one or more interactive inputs from the user to enable one or more predefined modes. For example, the one or more interactive inputs include drag, drop a video tile associated with the user over to a target audience group, switching the user or any combination thereof, and the like. In an exemplary embodiment of the present disclosure, the one or more predefined modes include a huddle mode, a ghosted mode, an incognito mode, a live audience mode, a chorus mode, and an announcer mode. Further, the action performing module 234 performs one or more interactive actions for enabling the one or more predefined model based on the received one or more interactive inputs and a predefined multimedia information. In an exemplary embodiment of the present disclosure, the one or more interactive actions for enabling the huddle mode include adding the user to the target audience group, allowing interaction between the target audience group, mute the interactions in the target audience group for other users not in the target audience group, providing access of interactions between the other users to the target audience group, reducing volume of the interactions in the target audience group via one or more controls available for the target audience group, providing one or more audio controls to the user, switching users between groups or a combination thereof. For example, in a huddle while playing a football game, those in the huddle can still hear audio from outside, but the audio from within the huddle is not available to those outside the group. The huddle mode can be applied in situations when there is a need to have a private conversation in a large group. For example, the one or more interactive actions for enabling the ghosted mode include providing access of the interactions in the target audience group the other users, mute the interaction of the other users for users of the target audience group or a combination thereof. This is akin to all the attendees being in a huddle mode except the attendees with Ghosted mode turned on. In an exemplary embodiment of the present disclosure, the one or more interactive actions for enabling the incognito mode include hiding users who enabled incognito mode from the other users, mute interactions of the users who enabled incognito mode from the other users, providing access of interactions of the other users to the users who enabled incognito mode and the like. For example, the one or more interactive actions for enabling the live-audience mode include transmitting audio from users in a virtual meeting with live-audience mode as a single mixed signal to a host and not to other users, stitching the mixed audio stream with the host's audio and transmitting the stitched mixed audio stream to all users and the like. For example, the mixed audio stream is stitched with the host's audio and sent to all the attendees to enable a feeling of being in a live audience. In an exemplary embodiment of the present disclosure, the one or more interactive actions for enabling the chorus mode include providing access of audios from all users in a segment directly to all other users in the segment. In an exemplary embodiment of the present disclosure, the one or more interactive actions for enabling the announcer mode include transmitting audio from an announcer to all users. For example, where the audio from someone designated as the announcer reaches anyone irrespective of the above-mentioned modes they are in. For example, there are situations where there's a need to talk privately with a select set of attendees. This requirement is usually addressed by a text-based chat conversation feature. However, there are several situations where it's difficult to communicate or collaborate over such text-based chat systems either due to the nature of the conversation or the real-time nature. In a real-life situation with in-person meetings, this is often accomplished by walking over to the person or the group of people and whispering in-ear. The computing system 104 enables a drag and drop type of visually interactive features where a video tile can be dragged over to the target audience group to create a “huddle”. In this mode, the group can talk amongst themselves and the chatter from the other attendees not in the huddle can be either muted or toned down via controls available for the group. This allows for the emulation of a real-life in-person interaction. There may be one or more such huddles that can be created in a meeting room. The attendees can switch between the groups by dragging their video tile to a different group. The computing system 104 also allows for pre-defined groups for different types of activities. In such situations, the audio controls may or may not be pre-determined by the application. For example, controls for attendees to opt-in to be part of a segment by self-selecting themselves, either by dragging their own video tile to a segment or by any other visually convenient scheme, to become part of it. These segments can be either pre-defined, created by the application or created dynamically by every attendee in the meeting.

The parameter determination module 236 receives one or more user inputs from the user for sharing the multimedia data with one or more specific users. In an exemplary embodiment of the present disclosure, the one or more user inputs include number of the one or more specific users, type of the one or more specific users to whom the multimedia is required to be shared, time duration for sharing the multimedia and the like. For example, in a test, time duration for sharing the screen with multiple questions may be 30 minutes. The parameter determination module 236 determines one or more multimedia parameters based on the received one or more inputs and predefined multimedia information. For example, the one or more multimedia parameters include a language, one or more visual styles of the multimedia data, one or more layouts of video tiles required to be displayed on one or more user devices associated with the one or more specific users and the like. Further, the parameter determination module 236 outputs the multimedia data on the user interface screen of the one or more user devices based on the received one or more user inputs and the determined one or more multimedia parameters. In an embodiment of the present disclosure, the one or more sharing controls are designed to allow the attendee to share items with specific attendees in a meeting. The computing system 104 can take content from the activity or local space, as well as audio or video from the user, and then provide it to the activity to display the content and audio or video in any way it prefers. The computing system 104 also has support for picking up audio or video streams from the cloud to the activity to display the content.

The action performing module 234 configured to receive one or more audio inputs and one or more background themes from the user. The one or more audio inputs include one or more background music tracks, timing of playing the one or more background music tracks, a music track when a correct answer is submitted, one or more music tracks for jukebox experience, order of playing the one or more background music tracks and the one or more music tracks and the like. Further, the action performing module 234 performs one or more background actions based on the received one or more audio inputs, the received request, type, state of applications and a set of predefined audio rules. For example, the set of predefined rules includes music to be played just before prompt for a virtual meeting. In an exemplary embodiment of the present disclosure, the one or more audio actions include playing the one or more background music tracks just before the prompt is displayed to all users, playing a music track when the correct answer is submitted, playing the one or more background music tracks and the one or more music tracks based on the received order of playing, applying the one or more background themes during conference session and playing the one or more background music tracks, the one or more music tracks or a combination thereof. For example, video conferencing is used for webinars in corporate events. In these scenarios, it's very typical for some background music at the beginning of these sessions before the presenters join the meeting. The background music is usually managed by a host and there are very few controls available other than increasing or decreasing the volume or changing tracks. Furthermore, the tracks are usually selected by the meeting host with almost no controls for the attendees. In an embodiment of the present disclosure, the background music and themes enable attendees to experience the feeling of a live meeting. The computing system 104 allows for a more granular and predetermined control of music based on different applications. For ex., in applications like Trivia or a Casino style game, the application can be programmed to play background music just before the prompt is displayed to all the attendees and a different track when the correct answer is submitted. The attendees can also submit tracks for a Jukebox like experience and the application can automatically play the music track based on a predetermined order or based on the relevance to the application or the application state. Such granular controls are useful to emulate a real-life in-person event in an online video conferencing session. In an embodiment of the present disclosure, a meeting host may split attendees into multiple segments with different privileges, controls, interaction modes or a combination thereof in an online activity. Attendees who are not in a segment may be in a pavilion witnessing the interaction between attendees in the segments. In an embodiment of the present disclosure, the segment is a mutually exclusive subcollection of attendees formed during a meeting to help with smooth and realistic operation of an activity. Further, the pavilion is a place from where attendees that are not part of any segment may witness an activity in progress without participating in it.

The notification generation module 238 is configured to generate one or more push notifications in a virtual meeting based on a predefined action information to take one or more actions during the virtual meeting. In an exemplary embodiment of the present disclosure, the one or more push notifications correspond to clickable actions. Further, the notification generation module 238 performs the one or more actions based on the generated one or more push notifications. In an exemplary embodiment of the present disclosure, the one or more actions include request for sign-up, request of attending a conference and the like.

In an embodiment of the present disclosure, the computing system 104 provides a declarative way to allow for creation of custom activities using various features and functionalities together. Further, when the user chooses an activity, the corresponding Activity Description Language (ADL) is loaded by the computing system 104. If the ADL is fully self-contained (as in the execution of the entire activity is fully covered in the ADL), then every step of the Activity is processed using ADL as an instruction set. Furthermore, If the ADL is not fully self-contained, then a program associated with the activity is loaded by the system. The Activity registers itself for events of the system. Additionally, an activity can also generate its own events. These events can call specific endpoints within the system, which can then propagate the events to other parts of the system. In an embodiment of the present disclosure, the computing system 104 provides an ability to create visually distinct area on the screen, such that the users in a group are in a sub-meeting, with different set of privileges or controls but still feel part of the larger meeting by hearing, seeing others not in the sub meeting or a combination thereof. The the computing system 104 allows an online meeting to break into a group of smaller focused conversations in areas called rooms, and an independent attendee not in any of the rooms can vicariously experience all the rooms simultaneously.

In operation, the user joins a meeting, and the computing system 104 establishes the connection for the user with the video conferencing API. Further, each user's device gets independent streams of all other attendees in the meeting. The user interface of the computing system 104 listens to control channel to manage availability of these streams to the user.

FIGS. 3A-3J are process flow diagrams illustrating an exemplary operation of the computing system 104 for facilitating interaction among users at real-time, in accordance with an embodiment of the present disclosure. At step 302a, the user joins a conversation. At step 304a, is determined if conversation is broken into segments. If yes, then at 306a, the user watch conversation from pavilion. At step 308a, it is determined if the user is added to the segment. 310a represents concept of segmentation and pavilion. If the user is added to the segment, the user is in a conversation at step 312a. Further, at step 304a, if the conversation is not broken into segments, the user is in a conversation at step 312a. Furthermore, block ‘A’ 314a depicts activity description language process. At step 302b activity is chosen. At step 304b, system interprets Activity Description language (ADL). At step 306b, activity starts. Further, at step 308b, based on ADL, system executes next step in activity. At step 310b, for that step based on ADL, system manages audio or video for the participants. At step 312b, it is determined if next step is required to be performed. If yes, then step 308b is performed. If no, at step 314b, it is determined if activity is ended. If in an activity, at step 316b, less conversation. 318b depicts concept of activity description language. Further, block ‘B’ 316a depicts personal space and granularity of sharing. At 320b, it is determined if the user is in an activity. If yes, at 322b, it is determined if items are in personal space. If yes, at 324b, items are viewed in personal space. At 326b, it is determined if items are required to be shared in personal space. If no, step 324b is performed. If yes, at 328b attendees are chosen to share with. At 330b, it is determined if the items are shared. If no, step 324b is performed. If yes, at 332b, items are displayed to selected attendees. At 334b, it is determined if the items are un-shared. If yes, step 324b is performed. If no, step 332b is performed. 336b depicts personal space and granularity of sharing.

Further, block ‘C’ 318a depicts segmenting and arrangement process. At 302c, it is determined segment is required to be formed. Further, at step 304c, multiple segments are set-up. At step 306c, attendees are assigned to segments. At 308c, video tiles are lay out to reflect segment structure. At 310c, the user is in a segment-based conversation. At 312c, it is determined if segment structure is required to be disabled. If yes, at 314c, the user is in a conversation. 316c depicts concept of segmenting and arrangement. Furthermore, block 320a depicts huddle mode. At step 318c, it is determined if the user is in a segment. At step 320c, it is determined if you want secret discussion. If yes, at 322c, audio is disabled for participants not in the segment. At step 324c, huddle mode is activated. At step 326c, it is determined if mode is back to open conversation. If yes, at step 328c, enable audio to be audible to all participants. At step 330c, the user is in a conversation. At step 320c, if output is no, block 330c is performed. Furthermore, 332c depicts huddle mode.

Furthermore, block ‘E’ 322a depicts ghosted mode. At step 302d, if the user is in segment. If yes, at 304d, it is determined if segment is isolated from the rest. If yes, at 306d, audio or video is disabled from participants not in the segment. At step 308d, ghosted mode is activated. At 310d, it is determined if mode is back to open conversation. If yes, at 312d, enable audio or video from participants not in the segment. At 314d, the user is in a conversation. At step 304d, if output is no, block 314d is performed. At step 310d, if output is no, block 308d is performed. Furthermore, 316d depicts ghosted mode. Further, block ‘F’ 324a depicts self-selection to segment. At step 318d, it is determined if the user join an existing segment. If yes, at 320d, it is determined if self-select into segments is enabled. At step 322d, drag own video tile to desired segment. Further, at 324d, video tile is now part of the segment. At 346d, inherit the properties of segment like huddle mode. At 328d, it is determined if segment is left. At 330d, the user is in a conversation without the segment. Furthermore, 332d depicts self-selection to segment.

Furthermore, block ‘G’ 326a depicts granularity of audio and video control. At step 302e, it is determined if a user is bothered about another attendee's audio or video. If yes, at 304e, modify attendee's audio and/or vide just for the user. At step 306e, it is determined if multiple actions are performed for same attendee's audio and/or video. If yes, at 310e, if rest attendee's audio and/or video. If yes, at 312e, enable audio of the attendee to all other attendees. At 314e, the user is in a conversation. 316e depicts granularity of audio and video control. Further, block ‘H’ 328a depicts booth mode. At 318e, it is determined if ad-hoc segment is required to be created. If yes, at 320e, find another attendee to create an ad-hoc segment. At 322e, it is determined if private talk is required. If yes, at 324e, enable booth mode for the segment. At 326e, disable all outgoing and incoming audio into the booth. At 328e, it determined if private conversation is complete. If no, step 324e is performed. If yes, at 330e, disable booth mode. At 332e, the user is in a conversation. 334e depicts the booth mode.

Further, block ‘I’ 330a depicts live audience mode. At 302f, live feedback is heard from all participants. At 304f, enter live audience mode. At 306f, disable audio from other participants to go to each other. At 308f, enable audio from other participants to come to the user only. At 310f, hear all other participants as live audience. At 312f, mix my audio with audio from the other participants. At 314f, send mixed audio from the user to all participants. At 316f, all other participants hear collective sound in the audio from me. 318f depicts the live audience mode process. Furthermore, block ‘J’ 332a depicts chorus mode. At 320f, hear from all participants simultaneously. At 322f, enter chorus mode. At step 324f, send audio from each participant to every other participant. At step 326f, each participant's device may merge the audio steams. At 328f, hear from all participants at the same time, while speaking. 330f depicts the chorus mode.

Furthermore, block ‘K’ 334a depicts rooms concept. At 302g, it is determined if focused attention is required for activity or conversation. At 304g, a room is created. At step 306g, attendees are added. At step 308g, audio from attendees outside the room is disabled. At 310g, room attendees view is limited to room. At 312g, attendees outside the room may listen and witness room activity and conversation. 314g depicts the room concept. Further, block ‘L’ 336a depicts server-side rendering. At 316g, it is determined if an activity is engaged from the cloud. If yes, at 318g, launch a server-side browser to go to cloud resource. At 320g, it is determined if user is connected to cloud resource. If yes, at 322g, cloud resources are shared with same or all attendees. At 324g, system sends audio, video and the like from clouds to each attendee. At 326g, the activity and the conversation are enjoyed. 328g depicts server-side rendering.

Further, block ‘M’ 338a depicts background and music concept. At 302h, it is determined if mood of the conversation is required to be customized. If yes, at 304h, it is determined if customized visual backdrop is required to be customized. If yes, at 306h, select an image or vide from local space or cloud. If no, at 308h, it is determined of background music is required to be customized. If yes, at 310h, select audio file from local space or audio stream from cloud. At 312h, it is determined if privileges to apply change to all attendees. If yes, at 314h, it is determined if content is from local space. If no, at 316h, it is determined if content is from cloud. If yes, at 318h, system sends media from cloud to each attendee. If yes, at 320h, send media from local space to each attendee. At 322h, set audio or visual backdrop for the conversation. At 324h, enjoy activity and conversation. 326h depicts background and music concept. Further, block ‘N’ 340a depicts group picture and video concept. At 328h, it is determined if moment is required to be captured. If yes, at 330h, it is determined if audio is required to be recorded or picture is required to be captured. If video is required to be recorded, at 332h, record video on server. If picture is required to be captured, at 334h, it is determined if manual or automated. If automated, at 336h, enable algorithm to determine moment to take picture. If manual, at 338h, countdown begins. At 340h, take picture on server. At 342h, generate media file on server. At 344h, notify meeting owner about generated file. 344h depicts group picture and video concept.

Furthermore, block ‘O’ 342a depicts multi-device concept. At step 302i, it is determined if the user is using another device to participate in the conversation. If yes, at 304i, join conversation from an additional device. At 306i, choose device purpose i.e., supported by the activity. At 308i, use device as input or output device to interact with the activity. At 310i, show up as one participant even with multiple devices. 312i depicts multi-device concept. Block ‘P’ 344a depicts face contouring and video stitching concept. Further, at 314i, it is determined if the user desires to customize how he looks. If yes, at 316i, client-side face detection contouring to make background transparent. At 318i, it is determined if appearance change is required. If yes, at 320i, apply ace filters to change appearance to match the theme. At 322i, it is determined if change to video tile shape is required. If yes, at 324i, change video tile from rectangle to another shape. At step 326i, it is determined if joined with another video tile shape. If yes, at step 328i, join with another video tiles to appear that attendees are together. If no, at 330i, independent video tile. 332i depicts face contouring and video stitching.

Further, block ‘Q’ 346a depicts screensharing and screen control concept. At 302j, it is determined if share screen or view and/or control another's screen is required. If yes, at 304j, it is determined if screen share is required. If yes, at 306j, share screen with a set of attendees. At 308j, it is determined if control of own screen is required. If yes, at 310j, give permission to selected attendee to control own screen. If output of 312j is no, at 314j, request screen sharing. At 316j, permission is granted. At 318j, view participant's screen. At 320j, it is determined if participant's screen is required to be control. If yes, at 322j, it is determined if permission is granted. If yes, at 324j, control participant's screen. 326j depicts screensharing and screen control concept.

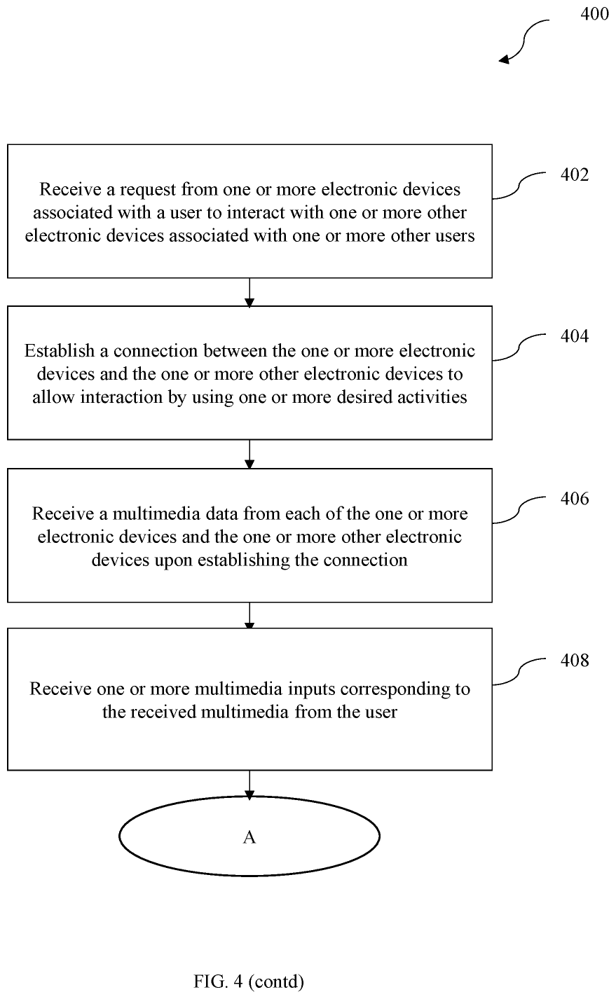

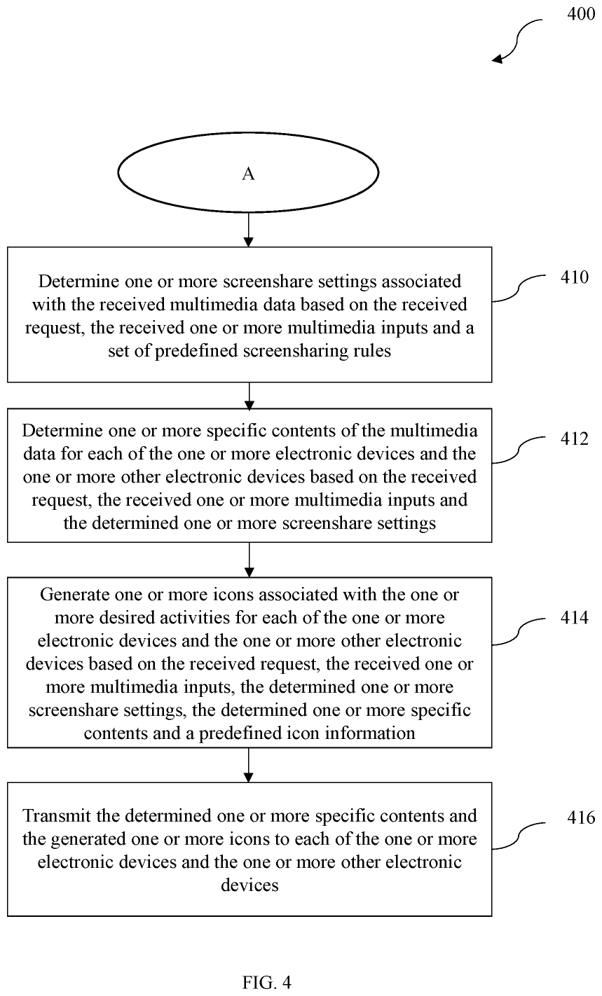

FIG. 4 is a process flow diagram illustrating an exemplary method for facilitating interaction among users at real-time, in accordance with an embodiment of the present disclosure. At step 402, a request is received from one or more electronic devices 102 associated with a user to interact with one or more other electronic devices 108 associated with one or more other users. In an exemplary embodiment of the present disclosure, the request includes type of the user, one or more desired activities for interaction between the user and the one or more other users, type of the one or more desired activities, type of the one or more users and the like. For example, the type of the user and the type of the one or more other users include one or more participants, one or more visitors, one or more administrators, one or more observers, one or more organizers, one or more creators or a combination thereof. In an embodiment of the present disclosure, the user is identified as a single attendee even if multiple electronic devices are used by the user as opposed to different attendee-id for each device. For example, the computing system 104 provides an ability for a user to participate in a meeting from multiple devices for specific parts of an activity, these may be related for both device inputs or outputs. In an exemplary embodiment of the present disclosure, the one or more electronic devices 102 and the one or more other electronic devices 108 may include a laptop computer, desktop computer, tablet computer, smartphone, wearable device, smart watch, and the like. The user may use the one or more electronic devices 102 to participate in a meeting. The user may use audio input, video input, keyboard or mouse input, drawing input, audio output, video output using the one or more electronic devices 102 or other device. In an embodiment of the present disclosure, the registered user is user registered in the computing system 104 with an email or phone number, usemame, a profile pic and the like. Further, an unregistered user exists only as a visitor. The one or more participants are users who participate in the one or more desired activities. The one or more visitors are users who just attend meetings. In an embodiment of the present disclosure, the one or more desired activities are end-user activities performed by the user and the one or more users using the computing system 104, such as playing poker, playing karaoke, watching a video in group and the like. Furthermore, the one or more administrators are users who administrate meetings. The one or more observers are users who just observe the one or more desired activities. The one or more organizers are users with extended privileges on the meetings. Further, the one or more creators are users who created the meetings. In an embodiment of the present disclosure, the meetings are current or future meetings with IDs.

At step 404, a connection is established between the one or more electronic devices 102 and the one or more other electronic devices 108 to allow interaction by using the one or more desired activities. In an embodiment of the present disclosure, one or more APIs allow the interaction by using the one or more desired activities. The one or more APIs include a video-conferencing API, a gaming API, an audio-conferencing API, or a combination thereof. In an embodiment of the present disclosure, the one or more APIs are exposed to applications, which provide necessary activities for end users to interact with, for a registration process by which the application is recognized a configuration process by which the application to describes itself and a communication process by which the application interacts with the platform.

At step 406, a multimedia data is received from each of the one or more electronic devices 102 and the one or more other electronic devices 108 upon establishing the connection. The received multimedia data is stored in a storage unit 206. In an exemplary embodiment of the present disclosure, the multimedia data include one or more audio streams, one or more video streams, one or more audio files, one or more video files, screensharing content, one or more images and one or more texts associated with the interaction between the user and the one or more other users. In an embodiment of the present disclosure, the multimedia may correspond to an item. The item corresponds to content used in a meeting that can be a screenshare, content produced by an activity or an audio/video stream from any source. There can be more than one item in the virtual meeting. Each Item has an Owner. Further, one or more attendees of the virtual meeting can be owners of the item.

At step 408, one or more multimedia inputs corresponding to the received multimedia are received from the user. In an exemplary embodiment of the present disclosure, the one or more inputs include instructions to split the user and the one or more others users in one or more groups, providing a different set of controls and a different set of privileges to each of the one or more groups, providing access of the multimedia data corresponding to each of the one or more groups to one or more administrators, mute the one or more administrators when they are in the one or more groups, disable one or more controls of the one or more administrators when they are in the one or more groups, deny access of interaction between the one or more administrators to the user and the one or more others users in the one or more groups, enable or disable a video feed from users, enable or disable an audio feed from users or a combination thereof. When a number of the users that enabled or disabled the audio feed or the video feed for a particular user surpasses a predefined threshold, the one of audio feed and the video feed are automatically enabled or disabled for the particular user for all other users. In an embodiment of the present disclosure, the one or more groups correspond to a collection of attendees i.e., users and not visitors, formed prior to or after the start of virtual meeting, they exist only in the context of a virtual meeting. An attendee may be part of the one or more groups, but an activity may limit that behavior. In an embodiment of the present disclosure, the one or more multimedia inputs may be provided using one or more controls to allowing alteration of video and/or audio stream using predefined filters provided by the computing system 104. The user may also use a video stitching feature to allow multiple video tiles from different attendees to give the appearance of being physically next to each other.

At step 410, one or more screenshare settings associated with the received multimedia data are determined based on the received request, the received one or more multimedia inputs and a set of predefined screensharing rules. In an exemplary embodiment of the present disclosure, the one or more screenshare settings includes one or more specific users allowed to view screen of each of the user and the one or more other users, one or more elements on screen allowed to be shared with each of the user and the one or more other users, a common space that is viewed by each of the user and the one or more other users, a personal space that exposes the one or more elements of screen sharing to the one or more specific users and a local space that only a presenter is allowed to one of: view and use. The computing system 104 is also configured to generate the common space, the personal space, and the local space. For example, the common space may be visible to every participant in meeting, the personal space for content is tailored by the activity for each user and the local space for non-activity generated content, such as desktop, that the user can access. In another embodiment of the present disclosure, the one or more screenshare settings are also defined by the user. For example, the one or more elements may be scoreboard, video tiles and the like. In an exemplary embodiment of the present disclosure, an application may be built using the APIs exposed by a platform. During a video conferencing session, attendees can communicate with each other via voice, video and screen sharing. Screen sharing includes sharing the presenter's desktop with different types of documents including, images and video. There are various controls for screen sharing where the presenter can choose to share the entire desktop or a single application.

At step 412, one or more specific contents of the multimedia data is determined for each of the one or more electronic devices 102 and the one or more other electronic devices 108 based on the received request, the received one or more multimedia inputs and the determined one or more screenshare settings.

At step 414, one or more icons associated with the one or more desired activities are generated for each of the one or more electronic devices 102 and the one or more other electronic devices 108 based on the received request, the received one or more multimedia inputs, the determined one or more screenshare settings, the determined one or more specific contents and the predefined icon information. For example, the one or more icons may correspond to scoreboards, name of players, name of participants, card images, win, lose and the like.

At step 416, the one or more images, the determined one or more specific contents and the generated one or more icons are transmitted to each of the one or more electronic devices 102 and the one or more other electronic devices 108. In an embodiment of the present disclosure, the determined one or more specific contents is outputted to allow interaction between the user and the one or more other users by performing the one or more desired activities. For example, certain activities like team-based games or casino style games, the granularity of sharing requirements vary greatly based on the application. For example, not all users may or should see the exact same window. In activities, like Taboo or Poker, the player (attendee holding the card) and the opponent teams may see card details while player's team should not be able to see any of the card details. All the attendees should be able to see and hear everything the player is communicating and also have access to common elements on the screen like video tiles, scoreboard and other common elements. Such activities require granular screen sharing controls and not just at an application window level but at an attendee level too.

In an embodiment of the present disclosure, the method 400 includes displaying one or more ongoing virtual meetings and one or more upcoming virtual meetings of the user on the user interface screen of the one or more electronic devices 102.

Further, the method 400 includes receiving one or more meeting inputs for a virtual meeting from the user. In an exemplary embodiment of the present disclosure, the one or more meeting inputs include a document to review, a meeting agenda, one or more action items, a set timer to review the document and the like. Further, the method 400 includes performing one or more meeting actions during the virtual meeting based on the received one or more meeting inputs. In an exemplary embodiment of the present disclosure, the one or more meeting actions include displaying the document during the virtual meeting, running the timer during the virtual meeting, defining layout of video tiles, displaying the meeting agenda during the virtual meeting and the like. For example, most prevalent video conferencing solutions enable the capabilities like breakout rooms, there are several limitations that prevent them from emulating real-life scenarios. Administrators or observers may witness the conversation happening in each of the breakout rooms but without participating or registering in any of the rooms. The method 400 includes enabling granular controls to selectively mute and disable certain controls for administrators or observers when they're in a room. The system also ensures that none of the attendees in the breakout rooms can hear any chatter between the administrators or observers.

Furthermore, the method 400 includes receiving one or more action inputs from the user for loading one or more applications associated with the one or more APIs. Further, the method 400 includes loading the one or more applications by using the one or more APIs based on the received one or more action inputs, a predefined loading agenda or a combination thereof. The method 400 includes determining one or more requirements of the loaded one or more applications based on the received request and the received one or more action inputs. Furthermore, the method 400 includes setting-up one or more required controls and one or more privileges for the loaded one or more applications based on the determined one or more requirements. The method 400 includes receiving one or more interaction inputs from the user to interact with the one or more applications for the one or more desired activities. The method 400 includes updating the one or more required controls and the one or more privileges for the user based on the received one or more interaction inputs. For example, the one or more required controls may be to share screen, audio, video, and the like from users. The one or more privileges include requesting users to share screen, audio and the like. For example, when the user logs on to the computing system 104, they are primarily interacting with the computing system 104 through an application. The entire experience of the user is controlled by a set of activities that are provided by various applications that are running on the computing system 104. The applications can either be loaded by the user through an explicit action or by the system automatically with a predefined program or agenda. When the application is loaded up, the computing system 104 understands the needs of the application and sets-up necessary privileges and controls for the application. As the user interacts with the application for an activity, the application communicates with the platform through the API to change the privileges and controls for the user.

Further, the method 400 includes receiving the multimedia data from the one or more electronic devices 102 associated with the user. Further, the method 400 includes broadcasting the received multimedia data at real-time to the one or more other electronic devices 108 associated with the one or more other users for synchronized sharing of the multimedia data. For example, in applications like Karaoke or video sharing, it's very important that all attendees always see the exact same screen as synchronized viewing is a critical need of the application. In the prevalent version of screen sharing, the presenter plays the video/audio stream which is broadcast to all other attendees. The attendees will experience a lag between when they get the audio/video feed vs the presenter. Furthermore, the quality of the audio/video feed as experienced by the attendees is determined by the uplink bandwidth quality of the presenter. To enable a more synchronized experience, the computing system 104 allows for certain types of content, such as video, audio, documents, to be rendered on the server and all the attendees get the exact same content. For example, the computing system 104 pre-fetch and load common content on the server and live broadcast to all attendees simultaneously.

The method 400 includes receiving one or more interactive inputs from the user to enable one or more predefined modes. For example, the one or more interactive inputs include drag, drop a video tile associated with the user over to a target audience group, switching the user or any combination thereof, and the like. In an exemplary embodiment of the present disclosure, the one or more predefined modes include a huddle mode, a ghosted mode, an incognito mode, a live audience mode, a chorus mode, and an announcer mode. Further, the method 400 includes performing one or more interactive actions for enabling the one or more predefined model based on the received one or more interactive inputs and a predefined multimedia information. In an exemplary embodiment of the present disclosure, the one or more interactive actions for enabling the huddle mode include adding the user to the target audience group, allowing interaction between the target audience group, mute the interactions in the target audience group for other users not in the target audience group, providing access of interactions between the other users to the target audience group, reducing volume of the interactions in the target audience group via one or more controls available for the target audience group, providing one or more audio controls to the user, switching users between groups or a combination thereof. For example, in a huddle while playing a football game, those in the huddle can still hear audio from outside, but the audio from within the huddle is not available to those outside the group. The huddle mode can be applied in situations when there is a need to have a private conversation in a large group. For example, the one or more interactive actions for enabling the ghosted mode include providing access of the interactions in the target audience group the other users, mute the interaction of the other users for users of the target audience group or a combination thereof. This is akin to all the attendees being in a huddle mode except the attendees with Ghosted mode turned on. In an exemplary embodiment of the present disclosure, the one or more interactive actions for enabling the incognito mode include hiding users who enabled incognito mode from the other users, mute interactions of the users who enabled incognito mode from the other users, providing access of interactions of the other users to the users who enabled incognito mode and the like. For example, the one or more interactive actions for enabling the live-audience mode include transmitting audio from users in a virtual meeting with live-audience mode as a single mixed signal to a host and not to other users, stitching the mixed audio stream with the host's audio and transmitting the stitched mixed audio stream to all users and the like. For example, the mixed audio stream is stitched with the host's audio and sent to all the attendees to enable a feeling of being in a live audience. In an exemplary embodiment of the present disclosure, the one or more interactive actions for enabling the chorus mode include providing access of audios from all users in a segment directly to all other users in the segment. In an exemplary embodiment of the present disclosure, the one or more interactive actions for enabling the announcer mode include transmitting audio from an announcer to all users. For example, where the audio from someone designated as the announcer reaches anyone irrespective of the above-mentioned modes they are in. For example, there are situations where there's a need to talk privately with a select set of attendees. This requirement is usually addressed by a text-based chat conversation feature. However, there are several situations where it's difficult to communicate or collaborate over such text-based chat systems either due to the nature of the conversation or the real-time nature. In a real-life situation with in-person meetings, this is often accomplished by walking over to the person or the group of people and whispering in-ear. The computing system 104 enables a drag and drop type of visually interactive features where a video tile can be dragged over to the target audience group to create a “huddle”. In this mode, the group can talk amongst themselves and the chatter from the other attendees not in the huddle can be either muted or toned down via controls available for the group. This allows for the emulation of a real-life in-person interaction. There may be one or more such huddles that can be created in a meeting room. The attendees can switch between the groups by dragging their video tile to a different group. The computing system 104 also allows for pre-defined groups for different types of activities. In such situations, the audio controls may or may not be pre-determined by the application. For example, controls for attendees to opt-in to be part of a segment by self-selecting themselves, either by dragging their own video tile to a segment or by any other visually convenient scheme, to become part of it. These segments can be either pre-defined, created by the application or created dynamically by every attendee in the meeting.

Further, the method 400 includes receiving one or more user inputs from the user for sharing the multimedia data with one or more specific users. In an exemplary embodiment of the present disclosure, the one or more user inputs include number of the one or more specific users, type of the one or more specific users to whom the multimedia is required to be shared, time duration for sharing the multimedia and the like. For example, in a test, time duration for sharing the screen with multiple questions may be 30 minutes. The method 400 includes determining one or more multimedia parameters based on the received one or more inputs and predefined multimedia information. For example, the one or more multimedia parameters include a language, one or more visual styles of the multimedia data, one or more layouts of video tiles required to be displayed on one or more user devices associated with the one or more specific users and the like. Further, the method 400 includes outputting the multimedia data on the user interface screen of the one or more user devices based on the received one or more user inputs and the determined one or more multimedia parameters. In an embodiment of the present disclosure, the one or more sharing controls are designed to allow the attendee to share items with specific attendees in a meeting. The method 400 includes taking content from the activity or local space, as well as audio or video from the user, and then provide it to the activity to display the content and audio or video in any way it prefers. The computing system 104 also has support for picking up audio or video streams from the cloud to the activity to display the content.

The method 400 includes receiving one or more audio inputs and one or more background themes from the user. The one or more audio inputs include one or more background music tracks, timing of playing the one or more background music tracks, a music track when a correct answer is submitted, one or more music tracks for jukebox experience, order of playing the one or more background music tracks and the one or more music tracks and the like. Further, the method 400 includes performing one or more background actions based on the received one or more audio inputs, the received request, type, state of applications and a set of predefined audio rules. For example, the set of predefined rules includes music to be played just before prompt for a virtual meeting. In an exemplary embodiment of the present disclosure, the one or more audio actions include playing the one or more background music tracks just before the prompt is displayed to all users, playing a music track when the correct answer is submitted, playing the one or more background music tracks and the one or more music tracks based on the received order of playing, applying the one or more background themes during conference session and playing the one or more background music tracks, the one or more music tracks or a combination thereof. For example, video conferencing is used for webinars in corporate events. In these scenarios, it's very typical for some background music at the beginning of these sessions before the presenters join the meeting. The background music is usually managed by a host and there are very few controls available other than increasing or decreasing the volume or changing tracks. Furthermore, the tracks are usually selected by the meeting host with almost no controls for the attendees. In an embodiment of the present disclosure, the background music and themes enable attendees to experience the feeling of a live meeting. The computing system 104 allows for a more granular and predetermined control of music based on different applications. For ex., in applications like Trivia or a Casino style game, the application can be programmed to play background music just before the prompt is displayed to all the attendees and a different track when the correct answer is submitted. The attendees can also submit tracks for a Jukebox like experience and the application can automatically play the music track based on a predetermined order or based on the relevance to the application or the application state. Such granular controls are useful to emulate a real-life in-person event in an online video conferencing session. In an embodiment of the present disclosure, a meeting host may split attendees into multiple segments with different privileges, controls, interaction modes or a combination thereof in an online activity. Attendees who are not in a segment may be in a pavilion witnessing the interaction between attendees in the segments. In an embodiment of the present disclosure, the segment is a mutually exclusive subcollection of attendees formed during a meeting to help with smooth and realistic operation of an activity. Further, the pavilion is a place from where attendees that are not part of any segment may witness an activity in progress without participating in it.

Furthermore, the method 400 includes generating one or more push notifications in a virtual meeting based on a predefined action information to take one or more actions during the virtual meeting. In an exemplary embodiment of the present disclosure, the one or more push notifications correspond to clickable actions. Further, the method 400 includes performing the one or more actions based on the generated one or more push notifications. In an exemplary embodiment of the present disclosure, the one or more actions include request for sign-up, request of attending a conference and the like.

The method 400 may be implemented in any suitable hardware, software, firmware, or combination thereof.

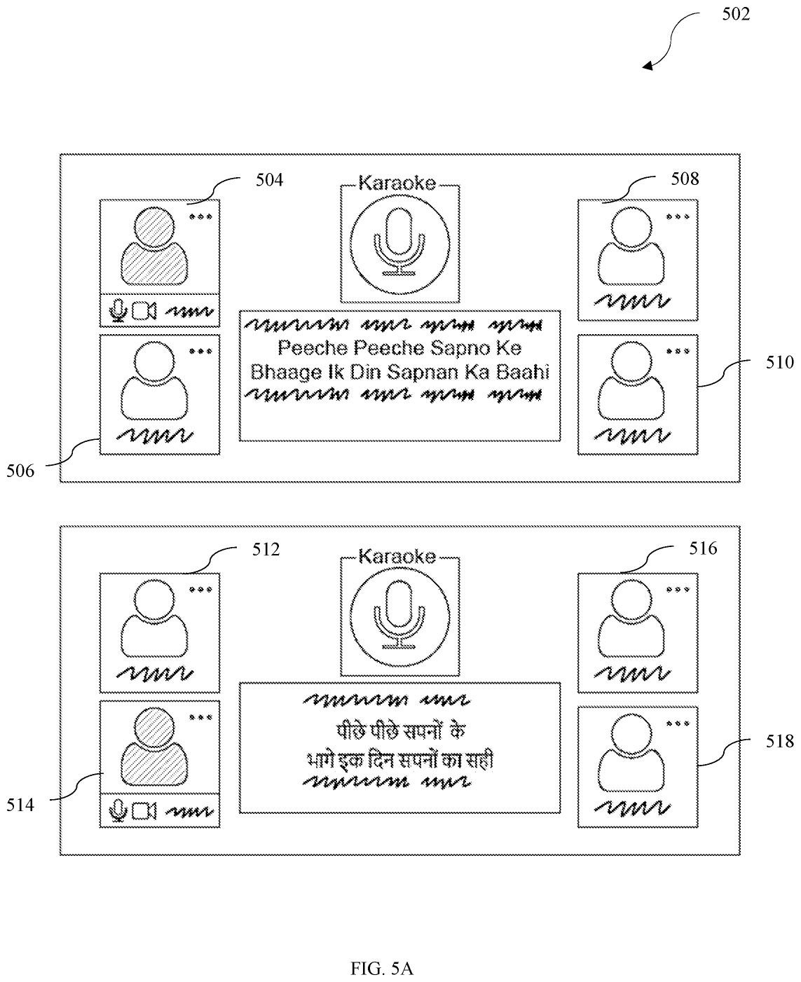

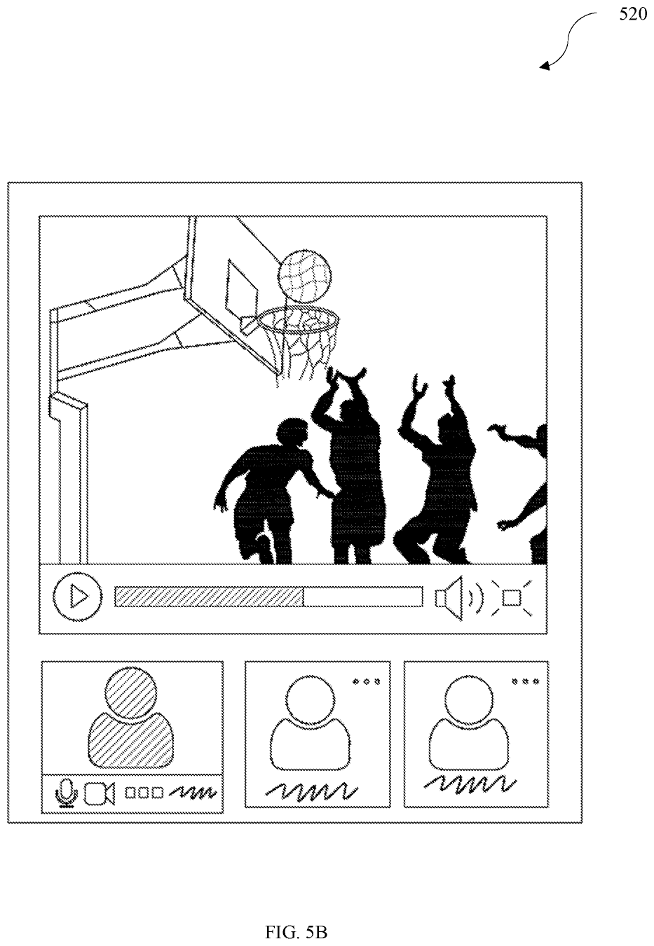

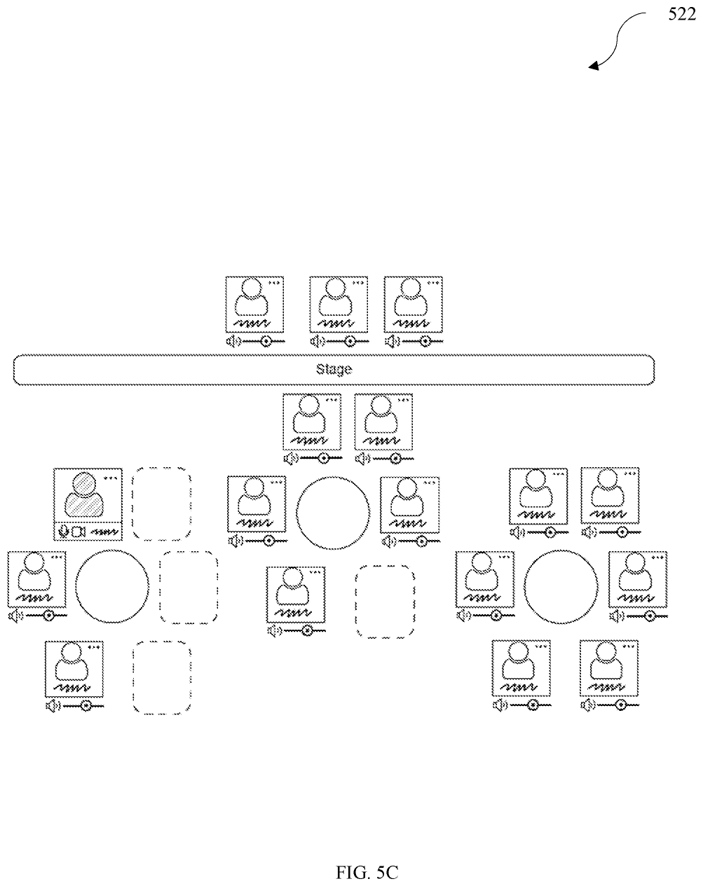

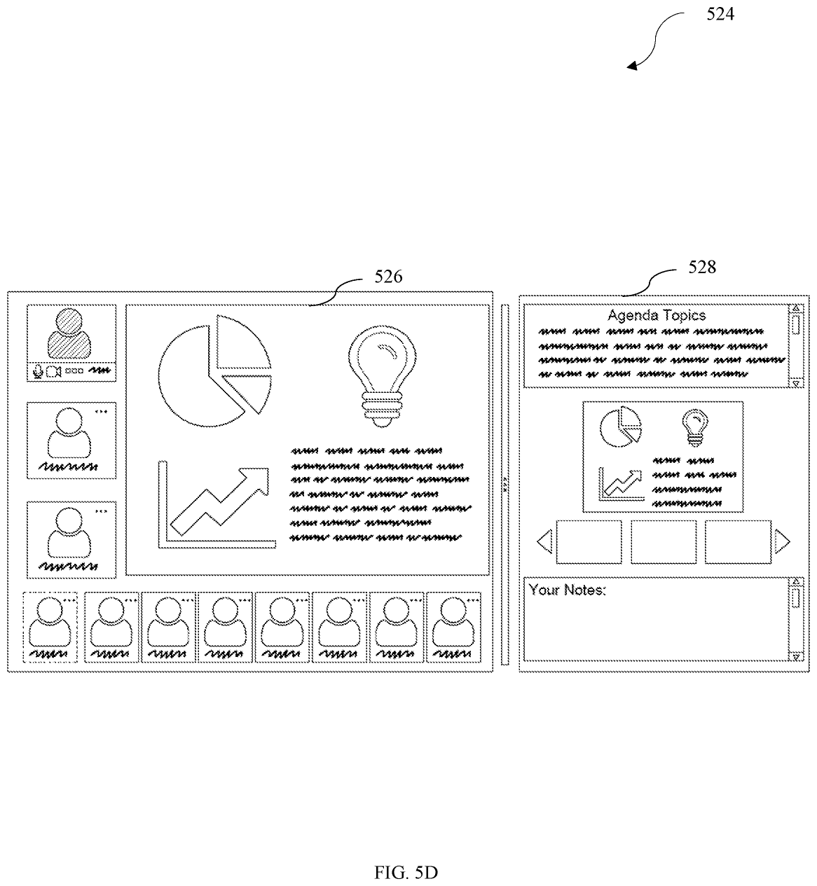

FIGS. 5A-5D are graphical user interface screens of the computing system 104 for facilitating interaction among users at real-time, in accordance with an embodiment of the present disclosure. The graphical user interface screen 502 of FIG. 5A displays granular audio controls for activities involving Breakout rooms. User-1 504, user-2 506, user-3 508 and user-4 510 are in group-1. Further, user-5 512, user-6 514, user-7 516 and user-8 518 are in group-2. For user-1 504, lyrics are in English. For user-6 514 lyrics are in Hindi. The graphical user interface screen 520 of FIG. 5B shows participants watching match. Each of the participants has different control, such as for volume, video and the like. Further, the graphical user interface screen 522 of FIG. 5C shows multiple groups, such that each group has multiple participants. The graphical user interface screen 524 of FIG. 5D shows the shared content 526 visible to all participants of the meeting. Further, the graphical user interface screen 524 also shows the private content 528 just visible to the participant sharing the screen.

Thus, various embodiments of the present computing system 104 provide a solution to facilitate interaction among users at real-time. The computing system 104 allows highly engaging experiences for casual yet structured activities using video and audio conferencing. There are several applications from casual gaming to group coaching lessons to serious enterprise applications where virtual online interactions need sophisticated controls from the underlying system. These applications require the system to be aware of the activity and provide the necessary granularity of controls to the application. In one such implementation, the computing system 104 is used for interactions between two or more people for a specific activity involving different permission scopes for screen sharing, audio & video controls. The computing system 104 provides for virtual interaction and collaboration with support for finer granularity of content sharing or viewing and simultaneous conversations. Further, the computing system 104 utilize existing video conferencing software through their APIs, for streaming video, audio and other content to the attendees. In an embodiment of the present disclosure, an activity can provide better control of the event to one or more organizers to maximize the experience for the attendees. Further, the computing system 104 allows a user to share their screen with others or give remote control access to their screen to a specific user. Furthermore, the computing system 104 allows an online meeting to break into a group of smaller focused conversations in areas called rooms, and an independent attendee not in any of the rooms can vicariously experience all the rooms simultaneously.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computing system for facilitating interaction among users at real-time, the computing system comprising:
one or more hardware processors; and
a memory coupled to the one or more hardware processors, wherein the memory comprises a plurality of modules in the form of programmable instructions executable by the one or more hardware processors, and wherein the plurality of modules comprises:
a request receiver module configured to receive a request from one or more electronic devices associated with a user to interact with one or more other electronic devices associated with one or more other users, wherein the request comprises type of the user, one or more desired activities for interaction between the user and the one or more other users, type of the one or more desired activities and type of the one or more users, wherein the type of the user and the type of the one or more other users comprise at least one of: one or more participants, one or more visitors, one or more administrators, one or more observers, one or more organizers and one or more creators, and wherein the user is identified as a single attendee;
a connection establishing module configured to establish a connection between the one or more electronic devices and the one or more other electronic devices to allow interaction by using the one or more desired activities, wherein one or more Application Programming Interface (APIs) allow the interaction by using the one or more desired activities, and wherein the one or more APIs comprise at least one of: a video-conferencing API, a gaming API and an audio-conferencing API;
a multimedia receiver module configured to receive a multimedia data from each of the one or more electronic devices and the one or more other electronic devices upon establishing the connection, wherein the received multimedia data is stored in a storage unit, and wherein the multimedia data comprise one or more audio streams, one or more video streams, one or more audio files, one or more video files, screensharing content, one or more images and one or more texts associated with the interaction between the user and the one or more other users;
an input receiver module configured to receive one or more multimedia inputs corresponding to the received multimedia from the user;
a screen setting determination module configured to determine one or more screenshare settings associated with the received multimedia data based on the received request, the received one or more multimedia inputs and a set of predefined screensharing rules;
a multimedia determination module configured to determine one or more specific contents of the multimedia data for each of the one or more electronic devices and the one or more other electronic devices based on the received request, the received one or more multimedia inputs and the determined one or more screenshare settings;
an icon generation module configured to generate one or more icons associated with the one or more desired activities for each of the one or more electronic devices and the one or more other electronic devices based on the received request, the received one or more multimedia inputs, the determined one or more screenshare settings, the determined one or more specific contents and a predefined icon information;
a data transmission module configured to transmit the determined one or more specific contents and the generated one or more icons to each of the one or more electronic devices and the one or more other electronic devices, wherein the determined one or more specific contents is outputted to allow interaction between the user and the one or more other users by performing the one or more desired activities.

2. The computing system of claim 1, wherein the one or more screenshare settings comprises one or more specific users allowed to view screen of each of the user and the one or more other users, one or more elements on screen allowed to be shared with each of the user and the one or more other users, a common space that is viewed by each of the user and the one or more other users, a personal space that exposes the one or more elements of screen sharing to the one or more specific users and a local space that only a presenter is allowed to one of: view and use, and wherein the one or more screenshare settings are defined by the user.

3. The computing system of claim 1, wherein the one or more inputs comprise at least one of: instructions to split the user and the one or more others users in one or more groups, providing a different set of controls and a different set of privileges to each of the one or more groups, providing access of the multimedia data corresponding to each of the one or more groups to one or more administrators, mute the one or more administrators when they are in the one or more groups, disable one or more controls of the one or more administrators when they are in the one or more groups, deny access of interaction between the one or more administrators to the user and the one or more others users in the one or more groups, one of: enable and disable a video feed from users, one of: enable and disable an audio feed from users, and wherein when a number of the users that have one of: enabled and disabled the one of: audio feed and video feed for a particular user surpasses a predefined threshold, the one of audio feed and the video feed are automatically one of: enabled and disabled for the particular user for all other users.

4. The computing system of claim 1, further comprising a meeting displaying module configured to display one or more ongoing virtual meetings and one or more upcoming virtual meetings of the user on the user interface screen of the one or more electronic devices.

5. The computing system of claim 1, further comprising a meeting management module configured to:
receive one or more meeting inputs for a virtual meeting from the user, wherein the one or more meeting inputs comprise a document to review, a meeting agenda, one or more action items and a set timer to review the document; and
perform one or more meeting actions during the virtual meeting based on the received one or more meeting inputs, wherein the one or more meeting actions comprise displaying the document during the virtual meeting, running the timer during the virtual meeting, defining layout of video tiles, and displaying the meeting agenda during the virtual meeting.

6. The computing system of claim 1, further comprising a data set-up module configured to:
receive one or more action inputs from the user for loading one or more applications associated with the one or more APIs;
load the one or more applications by using the one or more APIs based on at least one of: the received one or more action inputs and a predefined loading agenda;
determine one or more requirements of the loaded one or more applications based on the received request and the received one or more action inputs;
set-up one or more required controls and one or more privileges for the loaded one or more applications based on the determined one or more requirements;
receive one or more interaction inputs from the user to interact with the one or more applications for the one or more desired activities; and
update the one or more required controls and the one or more privileges for the user based on the received one or more interaction inputs.

7. The computing system of claim 1, further comprising a broadcasting module configured to:
receive the multimedia data from the one or more electronic devices associated with the user; and
broadcast the received multimedia data at real-time to the one or more other electronic devices associated with the one or more other users for synchronized sharing of the multimedia data.

8. The computing system of claim 1, further comprising an action performing module configured to:
receive one or more interactive inputs from the user to enable one or more predefined modes, wherein the one or more interactive inputs comprise at least one of: drag and drop a video tile associated with the user over to a target audience group, and switching the user, and wherein the one or more predefined modes comprise: a huddle mode, a ghosted mode, an incognito mode, a live audience mode, a chorus mode, and an announcer mode; and
perform one or more interactive actions for enabling the one or more predefined model based on the received one or more interactive inputs and a predefined multimedia information, wherein the one or more interactive actions for enabling the huddle mode comprise at least one of: adding the user to the target audience group, allowing interaction between the target audience group, mute the interactions in the target audience group for other users not in the target audience group, providing access of interactions between the other users to the target audience group, reducing volume of the interactions in the target audience group via one or more controls available for the target audience group, providing one or more audio controls to the user and switching users between groups, wherein the one or more interactive actions for enabling the ghosted mode comprise at least one of: providing access of the interactions in the target audience group the other users and mute the interaction of the other users for users of the target audience group, wherein the one or more interactive actions for enabling the incognito mode comprise at least one of: hiding users who enabled incognito mode from the other users, mute interactions of the users who enabled incognito mode from the other users and providing access of interactions of the other users to the users who enabled incognito mode, wherein the one or more interactive actions for enabling the live-audience mode comprise at least one of: transmitting audio from users in a virtual meeting with live-audience mode as a single mixed signal to a host and not to other users and stitching the mixed audio stream with the host's audio and transmitting the stitched mixed audio stream to all users, wherein the one or more interactive actions for enabling the chorus mode comprise providing access of audios from all users in a segment directly to all other users in the segment, and wherein the one or more interactive actions for enabling the announcer mode comprise transmitting audio from an announcer to all users.

9. The computing system of claim 1, further comprising a parameter determination module configured to:
receive one or more user inputs from the user for sharing the multimedia data with one or more specific users, wherein the one or more user inputs comprise number of the one or more specific users, type of the one or more specific users to whom the multimedia is required to be shared and time duration for sharing the multimedia; and
determine one or more multimedia parameters based on the received one or more inputs and predefined multimedia information, wherein the one or more multimedia parameters comprise a language, one or more visual styles of the multimedia data and one or more layouts of video tiles required to be displayed on one or more user devices associated with the one or more specific users; and
output the multimedia data on the user interface screen of the one or more user devices based on the received one or more user inputs and the determined one or more multimedia parameters.

10. The computing system of claim 8, wherein the action performing module is configured to:
receive one or more audio inputs and one or more background themes from the user, wherein the one or more audio inputs comprise at least one of: one or more background music tracks, timing of playing the one or more background music tracks, a music track when a correct answer is submitted, one or more music tracks for jukebox experience and order of playing the one or more background music tracks and the one or more music tracks; and
perform one or more background actions based on the received one or more audio inputs, the received request, type, state of applications and a set of predefined audio rules, wherein the one or more audio actions comprise at least one of: playing the one or more background music tracks just before the prompt is displayed to all users, playing a music track when the correct answer is submitted, playing the one or more background music tracks and the one or more music tracks based on the received order of playing, applying the one or more background themes during conference session and playing the one or more background music tracks and the one or more music tracks.

11. The computing system of claim 1, further comprising a notification generation module configured to:
generate one or more push notifications in a virtual meeting based on a predefined action information to take one or more actions during the virtual meeting, wherein the one or more push notifications correspond to clickable actions; and
perform the one or more actions based on the generated one or more push notifications.

12. A method for facilitating interaction among users at real-time, the method comprising:
receiving, by one or more hardware processors, a request from one or more electronic devices associated with a user to interact with one or more other electronic devices associated with one or more other users, wherein the request comprises type of the user, one or more desired activities for interaction between the user and the one or more other users, type of the one or more desired activities and type of the one or more users, wherein the type of the user and the type of the one or more other users comprise at least one of: one or more participants, one or more visitors, one or more administrators, one or more observers, one or more organizers and one or more creators, and wherein the user is identified as a single attendee;
establishing, by the one or more hardware processors, a connection between the one or more electronic devices and the one or more other electronic devices to allow interaction by using the one or more desired activities, wherein one or more Application Programming Interface (APIs) allow the interaction by using the one or more desired activities, and wherein the one or more APIs comprise at least one of: a video-conferencing API, a gaming API and an audio-conferencing API;
receiving, by the one or more hardware processors, receive a multimedia data from each of the one or more electronic devices and the one or more other electronic devices upon establishing the connection, wherein the received multimedia data is stored in a storage unit, and wherein the multimedia data comprise one or more audio streams, one or more video streams, one or more audio files, one or more video files, screensharing content, one or more images and one or more texts associated with the interaction between the user and the one or more other users;
receiving, by the one or more hardware processors, one or more multimedia inputs corresponding to the received multimedia from the user;
determining, by the one or more hardware processors, one or more screenshare settings associated with the received multimedia data based on the received request, the received one or more multimedia inputs and a set of predefined screensharing rules;
determining, by one or more hardware processors, one or more specific contents of the multimedia data for each of the one or more electronic devices and the one or more other electronic devices based on the received request, the received one or more multimedia inputs and the determined one or more screenshare settings;
generating, by one or more hardware processors, one or more icons associated with the one or more desired activities for each of the one or more electronic devices and the one or more other electronic devices based on the received request, the received one or more multimedia inputs, the determined one or more screenshare settings, the determined one or more specific contents and a predefined icon information; and
transmitting, by the one or more hardware processors, the determined one or more specific contents and the generated one or more icons to each of the one or more electronic devices and the one or more other electronic devices, wherein the determined one or more specific contents is outputted to allow interaction between the user and the one or more other users by performing the one or more desired activities.

13. The method of claim 12, wherein the one or more screenshare settings comprises one or more specific users allowed to view screen of each of the user and the one or more other users, one or more elements on screen allowed to be shared with each of the user and the one or more other users, a common space that is viewed by each of the user and the one or more other users, a personal space that exposes the one or more elements of screen sharing to the one or more specific users and a local space that only a presenter is allowed to one of: view and use, and wherein the one or more screenshare settings are defined by the user, and wherein the one or more inputs comprise at least one of: instructions to split the user and the one or more others users in one or more groups, providing a different set of controls and a different set of privileges to each of the one or more groups, providing access of the multimedia data corresponding to each of the one or more groups to one or more administrators, mute the one or more administrators when they are in the one or more groups, disable one or more controls of the one or more administrators when they are in the one or more groups, deny access of interaction between the one or more administrators to the user and the one or more others users in the one or more groups, one of: enable and disable a video feed from users, one of: enable and disable an audio feed from users, and wherein when a number of the users that have one of: enabled and disabled the one of: audio feed and video feed for a particular user surpasses a predefined threshold, the one of audio feed and the video feed are automatically one of: enabled and disabled for the particular user for all other users.

14. The method of claim 12, further comprising displaying one or more ongoing virtual meetings and one or more upcoming virtual meetings of the user on the user interface screen of the one or more electronic devices.

15. The method of claim 12, further comprising:
receiving one or more meeting inputs for a virtual meeting from the user, wherein the one or more meeting inputs comprise a document to review, a meeting agenda, one or more action items and a set timer to review the document; and
performing one or more meeting actions during the virtual meeting based on the received one or more meeting inputs, wherein the one or more meeting actions comprise displaying the document during the virtual meeting, running the timer during the virtual meeting, defining layout of video tiles, and displaying the meeting agenda during the virtual meeting.

16. The method of claim 12, further comprising:
receiving one or more action inputs from the user for loading one or more applications associated with the one or more APIs;
loading the one or more applications by using the one or more APIs based on at least one of: the received one or more action inputs and a predefined loading agenda;
determining one or more requirements of the loaded one or more applications based on the received request and the received one or more action inputs;
setting-up one or more required controls and one or more privileges for the loaded one or more applications based on the determined one or more requirements;
receiving one or more interaction inputs from the user to interact with the one or more applications for the one or more desired activities; and
updating the one or more required controls and the one or more privileges for the user based on the received one or more interaction inputs.

17. The method of claim 12, further comprising:
receiving the multimedia data from the one or more electronic devices associated with the user; and
broadcasting the received multimedia data at real-time to the one or more other electronic devices associated with the one or more other users for synchronized sharing of the multimedia data.

18. The method of claim 12, further comprising:
receiving one or more interactive inputs from the user to enable one or more predefined modes, wherein the one or more interactive inputs comprise at least one of: drag and drop a video tile associated with the user over to a target audience group, and switching the user, and wherein the one or more predefined modes comprise: a huddle mode, a ghosted mode, an incognito mode, a live audience mode, a chorus mode, and an announcer mode; and
performing one or more interactive actions for enabling the one or more predefined model based on the received one or more interactive inputs and a predefined multimedia information, wherein the one or more interactive actions for enabling the huddle mode comprise at least one of: adding the user to the target audience group, allowing interaction between the target audience group, mute the interactions in the target audience group for other users not in the target audience group, providing access of interactions between the other users to the target audience group, reducing volume of the interactions in the target audience group via one or more controls available for the target audience group, providing one or more audio controls to the user and switching users between groups, wherein the one or more interactive actions for enabling the ghosted mode comprise at least one of: providing access of the interactions in the target audience group the other users and mute the interaction of the other users for users of the target audience group, wherein the one or more interactive actions for enabling the incognito mode comprise at least one of: hiding users who enabled incognito mode from the other users, mute interactions of the users who enabled incognito mode from the other users and providing access of interactions of the other users to the users who enabled incognito mode, wherein the one or more interactive actions for enabling the live-audience mode comprise at least one of: transmitting audio from users in a virtual meeting with live-audience mode as a single mixed signal to a host and not to other users and stitching the mixed audio stream with the host's audio and transmitting the stitched mixed audio stream to all users, wherein the one or more interactive actions for enabling the chorus mode comprise providing access of audios from all users in a segment directly to all other users in the segment, and wherein the one or more interactive actions for enabling the announcer mode comprise transmitting audio from an announcer to all users.

19. The method of claim 12, further comprising:
receiving one or more user inputs from the user for sharing the multimedia data with one or more specific users, wherein the one or more user inputs comprise number of the one or more specific users, type of the one or more specific users to whom the multimedia is required to be shared and time duration for sharing the multimedia; and
determining one or more multimedia parameters based on the received one or more inputs and predefined multimedia information, wherein the one or more multimedia parameters comprise a language, one or more visual styles of the multimedia data and one or more layouts of video tiles required to be displayed on one or more user devices associated with the one or more specific users; and
outputting the multimedia data on the user interface screen of the one or more user devices based on the received one or more user inputs and the determined one or more multimedia parameters.

20. The method of claim 12, further comprising:
receiving one or more audio inputs and one or more background themes from the user, wherein the one or more audio inputs comprise at least one of: one or more background music tracks, timing of playing the one or more background music tracks, a music track when a correct answer is submitted, one or more music tracks for jukebox experience and order of playing the one or more background music tracks and the one or more music tracks; and
performing one or more background actions based on the received one or more audio inputs, the received request, type, state of applications and a set of predefined audio rules, wherein the one or more audio actions comprise at least one of: playing the one or more background music tracks just before the prompt is displayed to all users, playing a music track when the correct answer is submitted, playing the one or more background music tracks and the one or more music tracks based on the received order of playing, applying the one or more background themes during conference session and playing the one or more background music tracks and the one or more music tracks.

21. The method of claim 12, further comprising:
generating one or more push notifications in a virtual meeting based on a predefined action information to take one or more actions during the virtual meeting, wherein the one or more push notifications correspond to clickable actions; and
performing the one or more actions based on the generated one or more push notifications.
